(19) United States
(12) Patent Application Publication
(10) Pub. No.: US 2011/0162469 A1
(43) Pub. Date: Jul. 7, 2011

(54) FASTENING A STOP DISK

(76) Inventors: Hans-Juergen OBERLE, Rastatt (DE); Andreas Stock, Karlsruhe (DE); Andrew Pierson, Buehl (DE); Gilles Peter, Morsbronn Les Bains (FR)

(21) Appl. No.: 12/981,201

(22) Filed: Dec. 29, 2010

(30) Foreign Application Priority Data
Jan. 7, 2010 (DE) 10 2010 000 715.3

(51) Int. Cl. F16H 25/20

(52) U.S. Cl. 74/89.37

(57) ABSTRACT

A component is described for adjusting a movable part, of a vehicle in particular, having a gear shaft, which extends along an axis of rotation and has a receiving groove, and having a stop disk, which is situated in the receiving groove, the receiving groove being situated obliquely to the axis of rotation. Also described is a component in which the receiving groove has a contour, so that the stop disk is in contact with the receiving groove in a first contact area and in a second contact area in both the unloaded state and under load by a blocking force acting in a spatial direction parallel to the axis of rotation, the first contact area and the second contact area being situated on opposite sides of the stop disk. Also described is a component in which the receiving groove has an upper side and a lower side, at least the upper and/or lower sides of the receiving groove forming an acute angle with the axis of rotation. Also described is a gear shaft of the component.

### RELATED APPLICATION INFORMATION

The present application claims priority to and the benefit of German patent application no. 10 2010 000 715.3, which was filed in Germany on Jan. 7, 2010, the disclosure of which is incorporated herein by reference.

### FIELD OF THE INVENTION

The present invention relates to a component for adjusting a movable part, in particular of a vehicle, having a gear shaft, which extends along an axis of rotation and has a receiving groove, and having a stop disk situated in the receiving groove. The present invention also relates to a gear shaft of the component according to the present invention.

### SUMMARY OF THE INVENTION

A plurality of gear motors having a gear shaft, in particular having a spindle shaft, is known for use as an actuator in the automobile industry. The gear motors are used in automobiles for adjusting components, for example, for adjusting the height of vehicle seats. To prevent damage to the components that are to be adjusted, the adjustment travel is often limited by stop means. For example, DE 10 2008 028 726 A1, which describes the adjustment of a head rest via a gear motor having a spindle shaft is one such application.

The stop means used for limiting the adjustment travel must withstand high axial forces over its lifetime and must not produce any noise despite the severe vibration load in the vehicle.

An object of the exemplary embodiments and/or exemplary methods of the present invention is therefore to configure the interface between the stop means and the gear shaft to be robust, so that it is insensitive to both axial and radial increases in play between the stop means and the gear shaft and to deformations over its lifetime.

This object is achieved with the aid of a component for adjusting a movable part, in particular of a motor vehicle, having a gear shaft, which extends along an axis of rotation and has a receiving groove, and having a stop disk, which is situated in the receiving groove, the receiving groove being situated obliquely to the axis of rotation.

Due to the oblique position of the receiving groove in relation to the axis of rotation according to the present invention, a stop disk situated in the receiving groove remains in an essentially stable position despite the play between the stop disk and the receiving groove which is required for assembly. The stop disk is therefore pivoted very little or not significantly in the receiving groove when a blocking force occurs, acting in a spatial direction parallel to the axis of rotation, so that the interface of the stop disk in the receiving groove is low-noise and low-wear.

The inclination may be directed opposite the spatial direction, so that it is directed opposite the acting direction of the blocking force.

The stop disk may be secured in the receiving groove by a crimp joint.

In a specific embodiment, which also achieves this object, the receiving groove has a contour, so that the stop disk is in contact with the receiving groove in a first contact area and a second contact area in both the unloaded state and under load with a blocking force acting in a spatial direction parallel to the axis of rotation, so that the first contact area and the second contact area are situated on opposite sides of the stop disk. The movement of the stop disk is therefore also limited by the contact areas when the blocking force occurs.

The first contact area and the second contact area may each extend essentially radially about the axis of rotation, in particular essentially linearly.

In a specific embodiment, the first contact area is situated on the end of the receiving groove facing away from the axis of rotation and is situated on the side of the stop disk facing away from the blocking force, the second contact area being situated on the end of the receiving groove facing the axis of rotation and on the side of the stop disk facing the blocking force. The contact areas are therefore also situated on obliquely opposite areas of the receiving groove. They may be provided so that their distance from one another is as great as possible.

Due to this oblique spacing of the contact areas in relation to one another, the lever effect of the stop disk secured between the contact area is utilized, and the stop disk cannot or cannot significantly be pivoted even under load by the blocking force, so that it remains in the receiving groove and does so despite the play between the stop disk and the receiving groove which is required for assembly. The interface of the stop disk in the receiving groove is therefore low-noise and low-wear.

In a specific embodiment, which also achieves this object, the receiving groove has an upper side and a lower side, at least the upper side and/or the lower side of the receiving groove forming an acute angle to the axis of rotation. Therefore, at least the upper and/or the lower side(s) of the receiving groove have the inclination relative to the axis of rotation.

The acute angle may be situated on the side of the receiving groove facing the blocking force. Therefore the inclination has a first component of the spatial direction pointing opposite the spatial direction which is directed opposite the direction of action of the blocking force.

The receiving groove therefore has the second contact area having the stop disk may be on its side having the acute angle to the axis of rotation and on its end facing the axis of rotation. Furthermore, the receiving groove therefore has the second contact area having the stop disk may be on the side opposite the side having the acute angle to the axis of rotation on its end facing away from the axis of rotation.

The upper and/or lower side(s) of the receiving groove may have the spatial direction component. The upper and/or lower side(s) of the receiving groove also may have a second spatial direction component situated across the first spatial direction component. Depending on the width of the groove and the thickness of the stop disk situated in it, the stop disk is then provided in the receiving groove in such a way that it also has a third spatial direction component pointing opposite from the spatial direction. Therefore the contact areas between the stop disk situated in the receiving groove and the stop disk situated in it do not change significantly or at all when the blocking force occurs and a pivoting of the stop disk in the receiving groove in which the direction in which the third spatial direction component of the stop disk points is reversed is thereby prevented.

In the specific embodiment in which only the upper side is situated in the acute angle to the axis of rotation, the receiving groove on the lower side has on its end facing the axis of rotation a recess forming the second contact area, whereas in the specific embodiment in which only the lower side is situated in the acute angle to the axis of rotation, the receiving groove has a recess forming the first contact area on its upper side on its end facing away from the axis of rotation.

The receiving groove also may have an inner side, the inner side being situated across the upper and/or lower sides, in particular at a right angle to the upper and/or lower sides. Therefore the inner side if necessary likewise forms a limitation for the movement of the stop disk.

The component may have a gear motor by means of which the gear shaft is rotatable about the axis of rotation. The gear shaft may be provided as a spindle shaft.

In addition, the component may include a spindle nut situated on the gear shaft and cooperating with the latter, so that it moves along the gear shaft when the gear motor is driven. The spindle nut may cause the axial blocking force on the stop disk when the spindle nut is stopped against the stop disk.

The object is additionally achieved with the aid of a gear shaft of a component according to the present invention. The gear shaft extends along an axis of rotation and has a receiving groove to receive a stop disk. The contour of the receiving groove is provided so that the stop disk is in contact with the receiving groove both in the unloaded state as well as under the load of the blocking force in the first contact area and the second contact area, so that it remains in an essential stable manner in this position in both states. The interface of the stop disk having the receiving groove is therefore very low-noise and also very low-wear.

In a specific embodiment the contour of the receiving groove is provided so that the receiving groove is situated oblique to the axis of rotation. The receiving groove in particular has at least one upper side and/or one lower side, situated at an acute angle to the axis of rotation, so that the upper and/or lower sides form the bevel of the receiving groove.

The exemplary embodiments and/or exemplary methods of the present invention are described below on the basis of figures. The figures are merely examples and do not restrict the general scope of the present invention.

### BRIEF DESCRIPTION OF THE DRAWINGS

FIG. 1 shows an example of a component from the related art.

FIG. 2 shows a gear shaft according to the present invention having a receiving groove.

FIG. 3 shows section A-A through the gear shaft of FIG. 2, a stop disk being situated in the receiving groove.

FIG. 4 shows a stop disk.

FIG. 5 shows schematically a detail from another gear shaft according to the present invention having the receiving groove, the stop disk being situated in the receiving groove.

FIG. 6 shows schematically the behavior of the stop disk having the receiving groove situated at a right angle to the axis of rotation as in the related art.

FIG. 7 shows schematically the behavior of the stop disk in the case of a bevel of the receiving groove in the direction of axial blocking force.

FIG. 8 shows schematically the behavior of the stop disk in the case of a bevel of the receiving groove opposite the direction of the axial blocking force.

### DETAILED DESCRIPTION

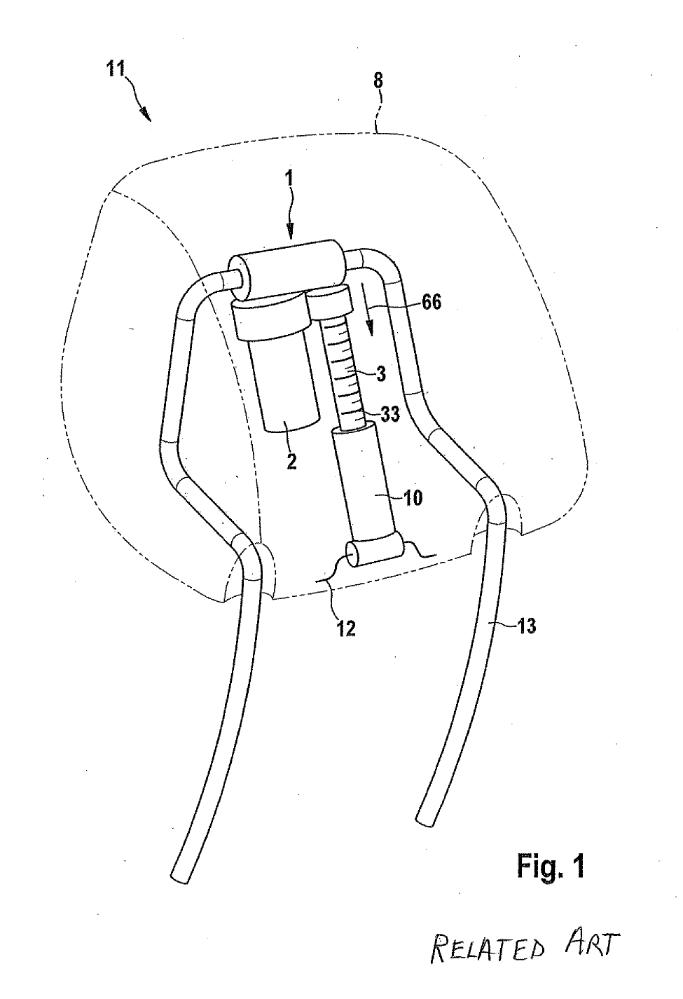

FIG. 1 shows an example of a part 8 to be moved, here a head rest having a component 1. Within the scope of the description of FIG. 1, the terms “head rest” and “part 8 to be moved” are used synonymously. Head rest 8 is adjustable in height via a gear motor 2 of component 1. Component 1 therefore has a gear shaft 3, here a spindle shaft, and is connected to two bars 13 of head rest 1, a spindle nut 10 embodied as a sleeve being situated on gear shaft 3. Spindle nut 10 is supported via a support 12 on the cushioned body of head rest 8.

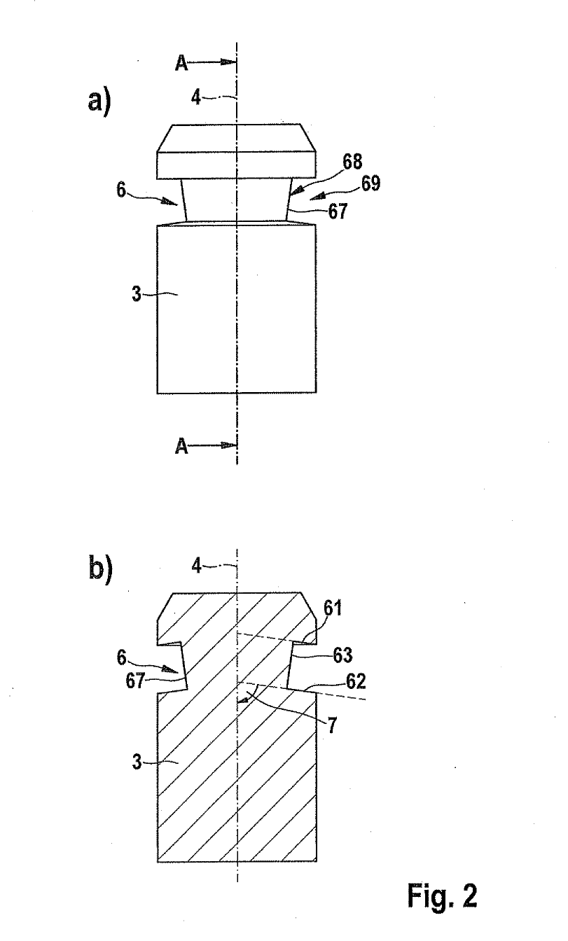

When gear motor 2 is driven, gear shaft 3 rotates about an axis of rotation 4 (see FIG. 2 b)). Spindle nut 10 has teeth (not shown here) which engage with teeth 33 on gear shaft 3, so that spindle nut 10 moves along spindle shaft 3 in or opposite a spatial direction 66 as spindle shaft 3 rotates. Bars 13 are therefore moved into or out of head rest 8.

FIG. 2 shows a gear shaft 3 according to the present invention, having a receiving groove 6, namely in a side view in FIG. 2 a) and in a section A-A through FIG. 2 a) and FIG. 2 b). It may be seen in FIG. 2 b) that receiving groove 6 is situated obliquely to an axis of rotation 4. Receiving groove 6 also has a lower side 62 bordering it and an upper side 61 bordering it, situated at an acute angle 7 to the axis of rotation 4.

In the example shown here, contour 67 of receiving groove 6 is provided in the form of a rectangle. Receiving groove 6 has a closed end 68 facing axis of rotation 4 and has an outwardly open end 69 facing away from axis of rotation 4. On its end 68 facing axis of rotation 4, receiving groove 6 is bordered by an inner side 63.

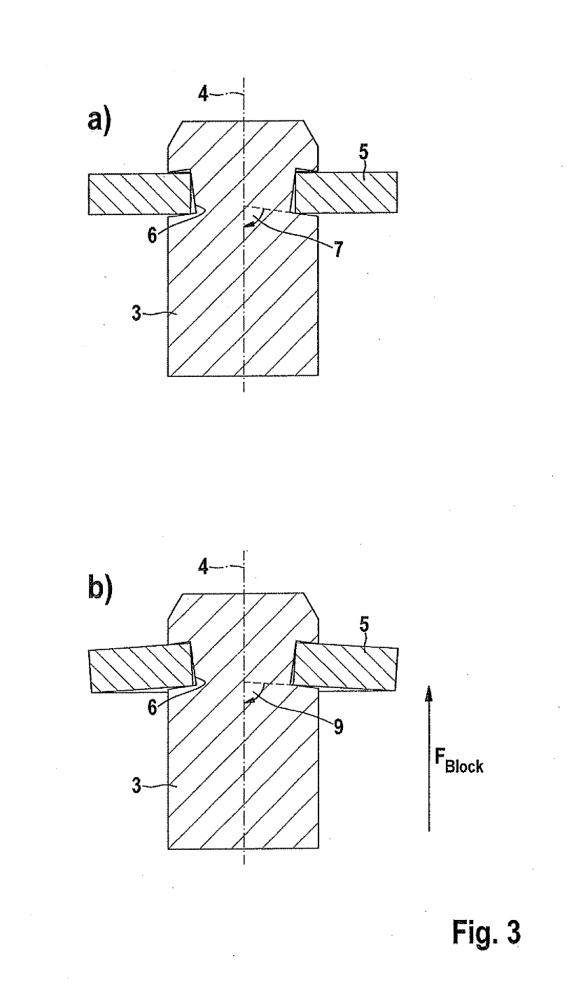

FIG. 3 shows section A-A through gear shaft 3 of FIG. 2, a stop disk 5 being situated in receiving groove 6. FIG. 3 a) shows stop disk 5 immediately after being secured in receiving groove 6. FIG. 3 b) shows stop disk 5 under load from a blocking force F_{blocking} acting parallel to axis of rotation 4. Stop disk 5 is easily deformed, but its position is essentially preserved with respect to its alignment relative to axis of rotation 4, so that even stop disk 5 itself remains in an acute stop disk angle 9 to axis of rotation 4.

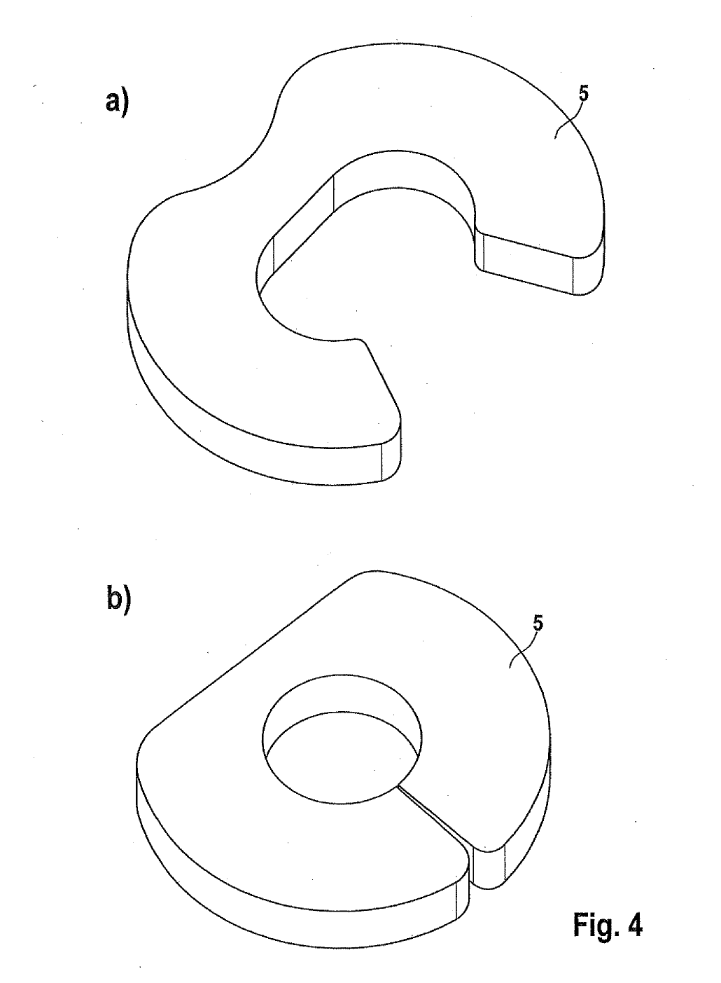

FIG. 4 shows a stop disk 5, namely FIG. 4 a) in its original form before being secured in a receiving groove 6 (not shown here) and in FIG. 4 b) in a form after being secured in receiving groove 6 (not shown here). Stop disk 5 is secured in receiving groove 6 via a crimp joint.

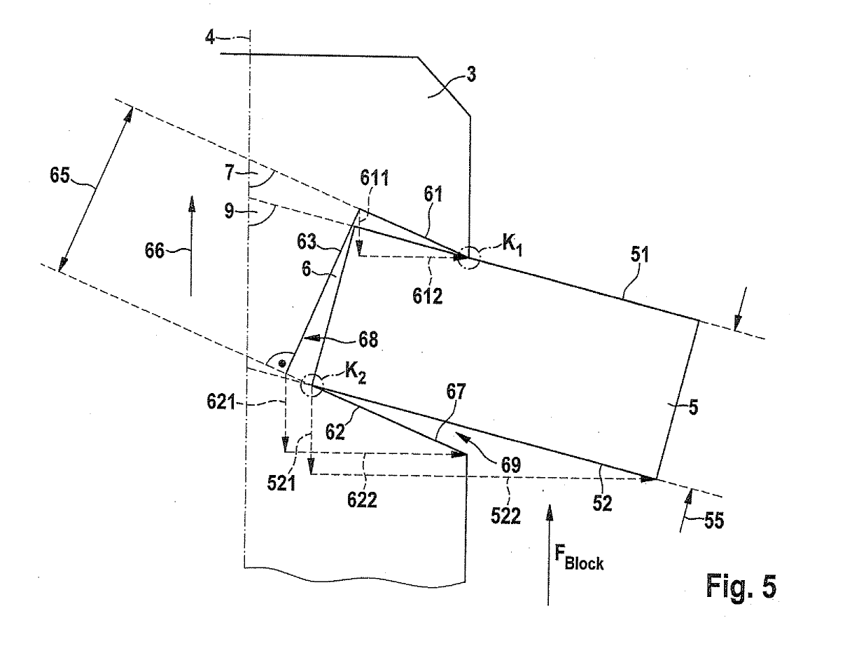

FIG. 5 shows schematically a detail of another gear shaft 3 according to the present invention, gear shaft 3 having receiving groove 6, and stop disk 5 being situated in receiving groove 6. This shows a sectional diagram through gear shaft 3, the section running through axis of rotation 4.

Receiving groove 6 has upper side 61 bordering it, lower side 62 bordering it and inner side 63 bordering it, inner side 63 bordering it being situated on end 68 of receiving groove 6 facing the axis of rotation. On its end 69 facing away from the axis of rotation, receiving groove 6 is also open toward the outside.

In order to be able to insert stop disk 5 into receiving groove 6, stop disk 5 has a thickness 55 smaller than width 65 of receiving groove 6, leaving a play between stop disk 5 and receiving groove 6.

It is apparent that upper and lower sides 61, 62 of receiving groove 6 are situated in an acute angle 7 to axis of rotation 4, so that receiving groove 6 is oriented obliquely to axis of rotation 4. Width 65 of receiving groove 6 and thickness 55 of stop disk 5 are selected so that stop disk 5 is also situated here in receiving groove 6 obliquely to axis of rotation 4. Stop disk 5 has an upper edge 51 and a lower edge 52, which are therefore also situated at an acute stop disk angle 9 to the axis of rotation.

Inner side 63 of receiving groove 6 is situated at a right angle to upper side 61 and to lower side 62.

Furthermore, it is shown on the example of lower side 62 and upper side 61 of receiving groove 6 that upper side 61 and lower side 62 of receiving groove 6 are each divisible into a first and a second spatial direction component 611, 612, 621, 622, first spatial direction component 611, 621 extending opposite direction space 66 running parallel to axis of rotation 4, and second spatial direction component 612, 622 extending across first spatial direction component 611, 621.

Upper edge 51 and lower edge 52 of top disk 5 may also each be decomposed into a first and a second spatial direction component 521, 522, first spatial direction component 521 extending opposite direction of space 66 and second spatial direction component 522 extending across first spatial direction component 521, shown here on the example of lower edge 52.

Stop disk 5 is in contact with receiving groove 6 in a first contact area K1 and a second contact area K2. Contact areas K1, K2 are areas extending essentially linearly in receiving groove 6. Contact areas K1, K2 are therefore visible as dots in this sectional diagram.

When stop disk 5 is loaded by a blocking force F_{blocking} acting in a spatial direction 66 and parallel to axis of rotation 4, stop disk 5 is pressed against contact points K1, K2. Stop disk 5 essentially retains its position in receiving groove 6 and its orientation relative to axis of rotation 4. Even with deformation of stop disk 5, there is no significant change in contact areas K1, K2.

And even as long as the play between stop disk 5 and receiving groove 6 increases under regular and/or permanent loading of stop disk 5, in particular by blocking force F_{blocking}, for example, due to wear, the orientation of stop disk 5 with respect to axis of rotation 4 remains essentially preserved. At any rate, as a result of the bevel of receiving groove 6, stop disk 5 cannot pivot into a position in which its first spatial direction component 521 is oriented in spatial direction 66 and thus in the direction of blocking force F_{blocking}.

Such a pivoting of stop disk 5 in receiving groove 6 and the resulting clatter are therefore impossible even with regularly alternating load on stop disk 5.

Contour 67 of receiving groove 6 is provided as a rectangle as in the specific embodiment of FIG. 2. This specific embodiment therefore provides for both a lower side and an upper side as well as an inner straight side 61, 62, 63 bordering receiving groove 6. Essentially, however, a specific embodiment which provides only recesses forming first and second contact areas K1, K2 is also conceivable, so that receiving groove 6 has only one upper side, only one lower side, if necessary one inner side or even no linear side 61, 62, 63.

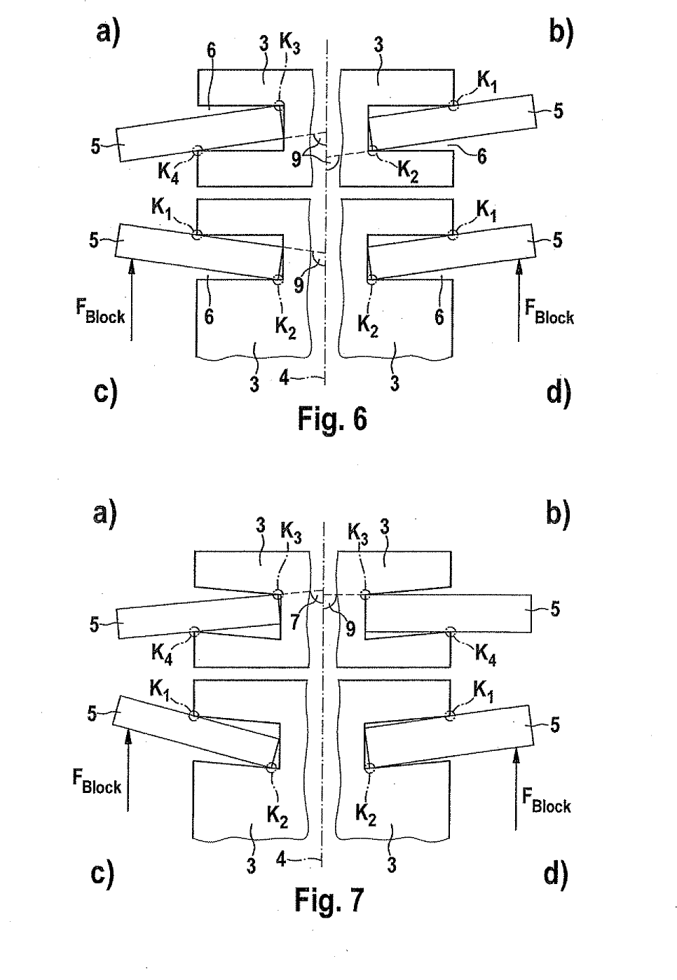

FIG. 6 shows schematically the behavior of stop disk 5 with receiving groove 6 situated at a right angle to axis of rotation 4 as in the related art.

FIGS. 6 a) and 6 b) show various starting situations in which the position of stop disk 5 in receiving groove 6 differs in which stop disk angle 9 to axis of rotation 4 it is situated in receiving groove 6. Stop disk 5 in FIG. 6 a) has an acute stop disk angle 9 to axis of rotation 4, so that its lower edge 52 and its upper edge 51 each have a first spatial direction component 521 (see FIG. 5) against spatial direction 66, which is directed opposite blocking force F_{blocking}. In FIG. 6 b), however, the angle of stop disk 5 to axis of rotation 4, this angle facing blocking force F_{blocking}, is an obtuse stop disk angle 9, so that first spatial direction component 521 points in spatial direction 66 and therefore in the direction of blocking force F_{blocking}.

In this sectional diagram, the contact areas in which stop disk 5 is in contact with receiving groove 6 are represented by dots.

In the case of contact areas K1, K2, K3, K4, the first contact area on the end of the receiving groove facing away from the axis of rotation and on the side of the stop disk facing away from the blocking force is identified as K1; the second contact area on the end of the receiving groove facing the axis of rotation and on the side of the stop disk facing the blocking force is identified as K2; a third contact area on the end of the receiving groove facing the axis of rotation and on the side of the stop disk facing away from the blocking force is identified as K3; and a fourth contact area on the end of the receiving groove facing away from the axis of rotation and on the side of the stop disk facing the blocking force is identified as K4.

In the starting situation of FIG. 6 a), stop disk 5 is in contact with receiving groove 6 in third and fourth contact areas K3, K4, but in the starting situation in FIG. 6 b), this occurs in first and second contact areas K1, K2.

FIGS. 6 c) and 6 d) show the behavior of stop disk 5 under load by blocking force F_{blocking}. FIG. 6 c) shows the behavior in the starting situation of FIG. 6 a), and FIG. 6 d) shows the behavior in the starting situation of FIG. 6 b).

Although contact areas K1, K2 and thus the orientation of stop disk 6 with respect to axis of rotation 4 remain essentially preserved, as shown in FIG. 6 d), in the starting situation of FIG. 6 b) under load by blocking force F_{blocking}.

However, in the starting situation of FIG. 6 a), in which the stop disk is in contact with second and third contact areas K3, K4, the stop disk is pivoted in the direction of blocking force F_{blocking} until it is in contact with first and second contact areas K1, K2 in receiving grooves 6. As shown in FIG. 6 c), the orientation of stop disk 5 with respect to axis of rotation 4 thereby changes and, it has an obtuse stop disk angle 9 under load by blocking force F_{blocking} on the side facing blocking force F_{blocking}, as in FIG. 6 d).

The pivoting and stopping of stop disk 5 on other contact areas K1, K2 not only increases the wear on stop disk 5 and receiving groove 6 but also causes a clattering noise.

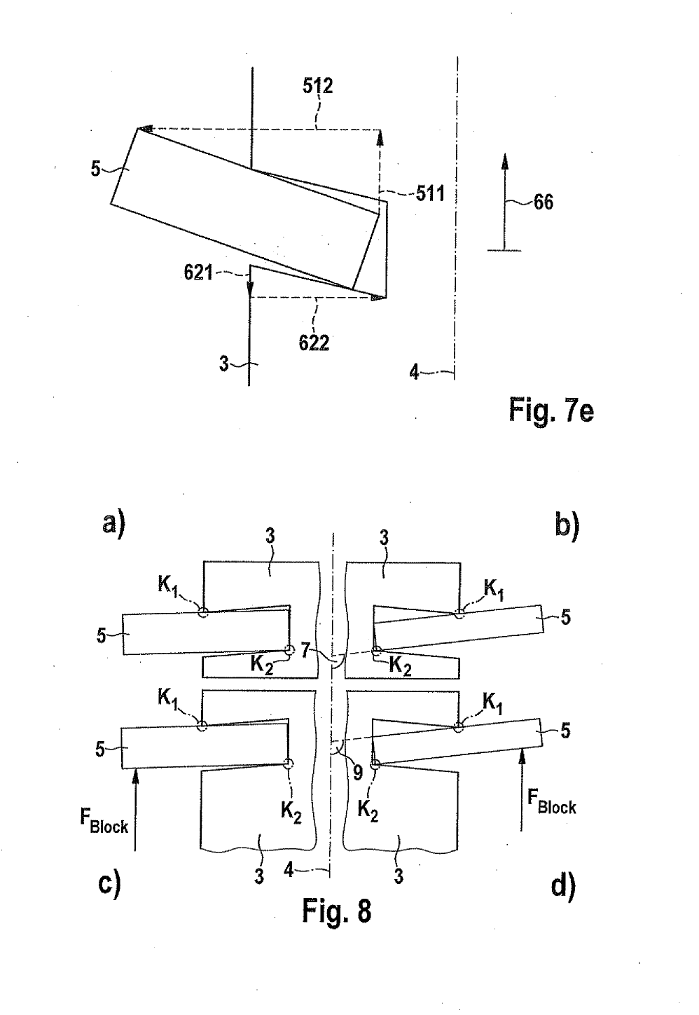

FIG. 7 shows schematically the behavior of stop disk 5 with a bevel of receiving groove 6 in the direction of axial blocking force F_{blocking}. Here again, FIGS. 7 a) and 7 b) show different starting situations for the orientation of stop disk 5 in receiving groove 6. Stop disk angle 9 in FIG. 7 a) is an acute angle, but stop disk angle 9 in FIG. 7 b) is approximately a right angle. In both cases, stop disk 5 is in contact with receiving groove 6 in third and fourth contact areas K3, K4. Here again, FIG. 7 c) shows the behavior of stop disk 5 under load by blocking force F_{blocking} in the starting situation of FIG. 7 a), and FIG. 7 d) shows the behavior of stop disk 5 under load by blocking force F_{blocking} in the starting situation of FIG. 7 b).

Stop disk 5 is pivoted here under load by blocking force F_{blocking} starting from both starting situations FIG. 7 a) and FIG. 7 b) until stop disk 5 is in contact with first and second contact areas K1, K2 in receiving groove 6, so that it has a spatial direction component 511 in the direction of blocking force F_{blocking} when blocking force F_{blocking} is applied. Spatial direction components 511, 512 of upper edge 51 of stop disk 5 are shown in FIG. 7 e). Here again, there is increased wear and a clattering noise is produced by the stopping of stop disk 5 against receiving groove 6.

FIG. 8 shows schematically the behavior of stop disk 5 with a bevel of receiving groove 6 opposite the direction of axial blocking force F_{blocking}. FIG. 8 therefore shows a gear shaft 3 according to the present invention. FIG. 8 c) shows again the behavior in the starting situation of FIG. 8 a), and FIG. 8 d) shows the behavior in the starting situation of FIG. 8 b).

The starting situations of FIGS. 8 a) and 8 b) show the position of stop disks in the receiving groove, where the stop disks of FIGS. 8 a) and 8 b) differ in their thickness (see FIG. 5), so that their stop disk angle 9 to the axis of rotation is different.

The stop disks of FIGS. 8 a) and 8 b) are each in contact with receiving grooves 6 in first contact area K1 and in second contact area K2. In addition, both lower side 61 and upper side 62 (see FIG. 5) of receiving groove 6 form an acute angle 7 to axis of rotation 4, so that they may be decomposed into a first and a second spatial direction component 611, 612, 621, 622, first spatial direction components 611, 612 of which are each oriented opposite the spatial direction 66.

If blocking force F_{blocking} acts on stop disk 5, the latter is pressed against first and second contact areas K1, K2. The position of stop disk 5 is therefore essentially preserved. Stop disk 5 is situated in an essentially stable position. In particular, stop disk 5 is not pivoted in such a way that the direction of first spatial direction components 611, 621 is reversed, and stop disk 5 is stopped against other contact areas K3, K4 of receiving groove 6.

The interface according to the present invention between stop disk 5 and receiving groove 6 is therefore low-wear and essentially noise-free.

Due to the targeted inclined position of receiving groove 6, an essentially stable seating of stop disk 5 both with and without loading by blocking force F_{blocking} is achieved. The inclined position also allows secure assembly of stop disk 5. To enable an optimal assembly and ensure an optimal operational performance, acute angle 7 and groove width 65 are variable.

What is claimed is:

1. A component for adjusting a movable part of a vehicle, comprising:
a gear shaft, which extends along an axis of rotation and which has a receiving groove; and
a stop disk, which is situated in the receiving groove, wherein the receiving groove is situated obliquely to the axis of rotation.

2. The component of claim 1, wherein the receiving groove has a contour, so that the stop disk is in contact with the receiving groove in a first contact area and a second contact area in an unloaded state and under load by a blocking force acting in a spatial direction parallel to the axis of rotation, and wherein the first contact area and the second contact area are situated on opposite sides of the stop disk.

3. The component of claim 2, wherein the first contact area is situated on the end of the receiving groove facing away from the axis of rotation and on the side of the stop disk facing away from the blocking force, and the second contact area is situated on the end of the receiving groove facing the axis of rotation and on the side of the stop disk facing the blocking force.

4. The component of claim 2, wherein the first contact area and the second contact area each extend essentially radially about the axis of rotation.

5. The component of claim 2, wherein the first contact area and the second contact area limit the movement of the stop disk in the spatial direction.

6. The component of claim 1, wherein the receiving groove has an upper side and a lower side, and wherein at least one of the upper side and the lower side of the receiving groove forms an acute angle with the axis of rotation.

7. The component of claim 6, wherein it has an inner side that is situated across the at least one of the upper side and the lower side at a right angle to the at least one of the upper side and the lower side.

8. The component of claim 6, wherein the acute angle is situated on the side of the receiving groove facing the blocking force.

9. The component of claim 6, wherein the at least one of the upper side and the lower side of the receiving groove each have a spatial direction component, which is directed opposite the blocking force.

10. The component of claim 1, further comprising:
a gear motor by which the gear shaft is rotatable about the axis of rotation.

11. The component of claim 1, wherein the gear shaft is a spindle shaft.

12. The component of claim 1, further comprising:
a spindle nut, which is situated on the gear shaft and cooperates with the latter, so that it moves along the gear shaft when the gear motor is driven.

13. The component of claim 12, wherein the blocking force acts on the stop disk when the spindle nut is in contact with it.

14. A gear shaft for use with a component for adjusting a movable part of a vehicle, comprising:
a gear shaft arrangement, which extends along an axis of rotation and which has a receiving groove, wherein a stop disk is situated in the receiving groove, and wherein the receiving groove is situated obliquely to the axis of rotation.
